(19) United States
(12) Patent Application Publication
(10) Pub. No.: US 2012/0014709 A1
(43) Pub. Date: Jan. 19, 2012

(54) ELECTROGRAPHIC PRINTING APPARATUS

(76) Inventor: Michael Pohlt, Muenchen (DE)

(21) Appl. No.: 13/184,672

(22) Filed: Jul. 18, 2011

(30) Foreign Application Priority Data
Jul. 19, 2010 (DE) 10 2010 036 480.0

(51) Int. Cl. G03G 21/00; G03G 15/16

(52) U.S. Cl. 399/98; 399/250; 399/296

(57) ABSTRACT

In an electrographic printing apparatus, a charge image carrier has charge images generated thereon of images to be printed. A developer station develops the charge images into an image film with carrier fluid and embedded toner images. A transfer unit receives the image film from the charge image carrier and transfers the image film onto a printing substrate. A fixing station fixes the image film on the printing substrate. A carrier fluid recovery device is arranged between the fixing station and the transfer unit, and recovers carrier fluid from carrier fluid vapor occurring in the fixing station and supplies the recovered carrier fluid to the transfer unit.

### BACKGROUND

To print a printing substrate—for example a single sheet or a belt-shaped recording material made of the most varied materials, for example from paper or thin plastic or metal films—it is known to generate image-dependent charge images on a charge image carrier (for example a photoconductor) that correspond to the images to be printed, comprised of regions that are to be inked and regions that are not to be inked. The regions of the charge images that are to be inked are made visible on the charge image carrier as toner images via toner particles with a developer station. The toner image that is thereby generated is subsequently transfer-printed onto the printing substrate in a transfer printing zone and fixed there.

A developer fluid having at least charged toner particles and carrier fluid can thereby be used to ink the charge images. Possible carrier fluids are hydrocarbons or silicone oil, among others.

One method for such an electrophoretic printing in digital printing systems is known from WO 2005/013013 A2 (US 2006/0150836 A1, DE 10 2005 055 156 B3), for example. After the charge images of the images to be printed have been generated on the charge image carrier, these are inked with toner particles into toner images by a developer station. Here a carrier fluid containing silicone oil with color particles (toner particles) dispersed in it is thereby used as a liquid developer. The feed of the liquid developer to the charge image carrier can take place via a developer roller to which the liquid developer is supplied via an inking roller. The image film generated on the charge image carrier in the development—which image film is made of toner images embedded in carrier fluid—is subsequently accepted from the charge image carrier by a transfer unit and is transferred onto the printing substrate in a transfer printing zone.

In these printing methods using liquid developer, the process of electrophoresis is thus used to transfer toner particles in the carrier fluid to the printing substrate via a transfer element (for example a transfer roller or a transfer belt) arranged in the transfer unit. The solid, electrically charged toner particles thereby migrate through the carrier fluid as a transport medium to the printing substrate, wherein the transport can be controlled by an electrical field between the transfer element and the printing substrate. The layer separates from the carrier fluid after the contact region (nip=transfer printing zone) between the transfer element and the printing substrate in a region depleted of toner particles, such that the toner particles are deposited on the printing substrate with high efficiency. In addition to the toner particle charge and the electrical field, a requirement for this is the provision of a sufficiently thick carrier fluid layer through which the toner particles can migrate.

The transfer of the image film onto the printing substrate requires particular measures to achieve a good transfer printing efficiency. The image film—and therefore the print image—on the transfer element comprises carrier fluid and toner particles that can move in the carrier fluid, possibly supplemented with additional auxiliary substances (for example charge control substances). The goal in this process step is the optimally complete depositing of all toner particles on the printing substrate. The transfer from carrier fluid onto the printing substrate is thereby required for the transport of the toner particles; however, the carrier fluid alone contains no print image information and incurs energy and material costs in the subsequent fixing. Carrier fluid in too-little quantities conveys adhesion forces to the transfer element and to the printing substrate and, given a highly concentrated print image, provides for an intensified reverse reaction of toner particles at the transfer element given a small movement range. Only given a sufficient quantity of carrier fluid so that the toner particles can be rearranged in the carrier fluid (for example under the influence of an electrical field) can the carrier fluid separate in a clear area and the toner particles remain at the printing substrate.

The principle of electrophoresis can be used in order to achieve a good transfer printing efficiency for the toner particles. Here the effect of an electrical field on the toner particles is utilized. For this a relatively thick film of carrier fluid is required that is dependent on the printing substrate. Only in this way can an accumulation of the toner particles on the printing substrate side in the transfer printing zone be achieved, and therefore a separation of the carrier fluid between printing substrate and transfer element over the toner image.

If the principle of electrophoresis is used in transfer printing, a large quantity of carrier fluid is required, with the consequence that a great deal of carrier fluid arrives at the printing substrate because only a portion of the carrier fluid cleaves at the transfer element. The other part remains on the printing substrate, wherein carrier fluid also penetrates into the printing substrate. This leads to a discharge of carrier fluid through the printing substrate, and therefore to costs due to the consumption of carrier fluid. The carrier fluid is thereby of no use for printing because the color pigments are transported with the toner particles.

When the image film made of carrier fluid and toner particles has been transfer-printed onto the printing substrate, these must still be fixed. For this the printing substrate is normally heated with the image film so that the carrier fluid vaporizes, the toner particles fuse or melt, and bond with the printing substrate. The re-use of the carrier fluid (present as vapor in the fixing station) in the printing process is sought for cost reasons. From US 2001/0017997 A1 it is known to remove excess carrier fluid from the charge image carrier via a belt, to vaporize the excess carrier fluid, to condense the carrier fluid vapor into carrier fluid again, and to supply the obtained carrier fluid to the developer station.

From DE 10 2004 009 986 B3, for reasons of environmental protection it is known to condense the vapor arising during the printing in an ink printing apparatus and to dispose of it as a waste product.

One disadvantage of the method according to US 2001/0017997 A1 is that the returned carrier fluid is supplied to the developer station. Namely, in addition to the carrier fluid a fluid regained after the fixing has water and other contents from the printing substrate, the use of which in the developer station can lead to difficulties in the electrophoretic printing process.

### SUMMARY

It is an object to specify an electrographic printing apparatus in which the carrier fluid regained after the fixing process is optimally used, and thereby cannot lead to disruptions in the printing process.

In an electrographic printing apparatus, a charge image carrier has charge images generated thereon of images to be printed. A developer station develops the charge images into an image film with carrier fluid and embedded toner images. A transfer unit receives the image film from the charge image carrier and transfers the image film onto a printing substrate. A fixing station fixes the image film on the printing substrate. A carrier fluid recovery device is arranged between the fixing station and the transfer unit, and recovers carrier fluid from carrier fluid vapor occurring in the fixing station and supplies the recovered carrier fluid to the transfer unit.

### BRIEF DESCRIPTION OF THE DRAWINGS

FIG. 1 is a principle representation of an electrographic printing apparatus with two print groups as an example;

FIG. 2 is a principle representation of a print group in which the transfer unit has a conditioning device of a first embodiment;

FIG. 3 is a principle representation of a print group in which the transfer unit has a conditioning device of a second embodiment; and

FIG. 4 is a principle representation of a print group in which the transfer unit has a conditioning device of a third embodiment.

### DESCRIPTION OF THE PREFERRED EMBODIMENTS

For the purposes of promoting an understanding of the principles of the invention, reference will now be made to preferred embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included.

In the electrographic printing apparatus according to the preferred embodiments the following is provided:

a charge image carrier on which are generated charge images of the images to be printed,

a developer station that, with a liquid developer having at least carrier fluid and charged toner particles, develops the charge images at a carrier fluid with image film having embedded toner images,

a transfer unit having a transfer element, which transfer unit receives the image film from the charge image carrier at a transfer point and transfers said image film onto the printing substrate in a transfer printing zone, and

a fixing station that fixes the image film on the printing substrate, a carrier fluid recovery device being arranged between the fixing station and the transfer unit, the carrier fluid recovery device converting the carrier fluid vapor occurring in the fixing station into carrier fluid and supplying it to the transfer unit.

In the printing apparatus the recovered carrier fluid is transferred onto the image film in the transfer unit in order to be able to improve the transfer printing according to the electrophoresis principle, wherein the disadvantages specified above in the cleaving of the image film in the transfer printing zone are avoided.

The printing apparatus according to the preferred embodiments therefore has the following advantages:

The transfer process is supplied with a sufficient quantity of carrier fluid in order to achieve a good efficiency in the transfer printing of the image film onto the printing substrate without additional carrier fluid having to be supplied to the overall process before the transfer unit.

An efficient usage of the carrier fluid is achieved via circulation in a small loop.

The contamination of process steps upstream of the transfer printing with discharge substances from the printing substrate is avoided.

The recovered carrier fluid is only transferred onto the transfer element after the acceptance of the image film. The preceding process steps can thereby be executed with little carrier fluid, which ensures a better detail mapping in the print image.

A good print image on the printing substrate is achieved since the additional carrier fluid is applied to an image film present on the transfer element; the toner particles thereby remain at rest.

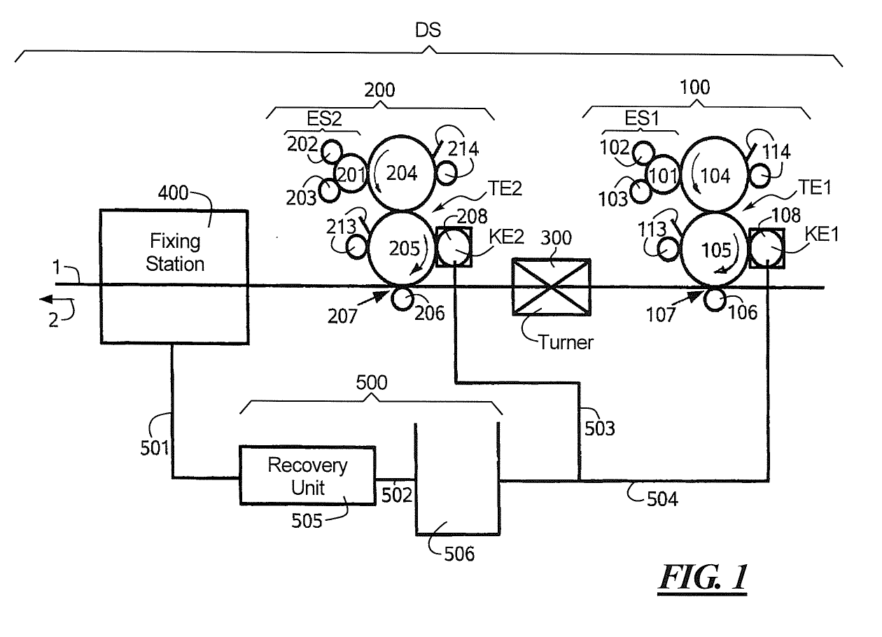

FIG. 1 shows the components of a printing apparatus DS with two print groups 100, 200. The design of the print groups 100, 200 is known from WO 2005/013013 A2 (US 2006/0150836 A1, DE 10 2005 055 156 B3), for example; WO 2005/013013 A2 is herewith incorporated into the disclosure. A turner 300 for the printing substrate web 1 can be provided between the print groups 100 and 200. A fixing station 400 that fixes the image film on the printing substrate 1 is arranged at the output of the print group 200. The printing substrate 1 is transported through the printing apparatus DS in the direction of the arrow 2.

The printing apparatus DS according to FIG. 1 is shown only as an example; it can also be comprised of a print group, or more than two print groups can be provided. The front side and the back side of the printing substrate 1 can be printed with the print groups 100, 200 that are arranged on the same side of the printing substrate 1. For this the turner 200 for the printing substrate 1 is used that turns the printing substrate 1 before it is supplied to the print group 200. If the print groups 100, 200 are arranged on both sides of the printing substrate 1, a turner 300 can be omitted. Only one fixing station 400 is provided for the printing apparatus DS; however, a fixing station can be arranged depending on the print group 100, 200.

The print groups 100, 200 respectively have the following components:
a charge image carrier 104, 204 on which are generated charge images of the images to be printed; for this a regeneration exposure, a charging station and a character generator (these components are not shown in the Figure—refer in this regard to WO 2005/013013 A2) can be provided along a rotating charge image carrier 104, 204, a photoconductor drum in FIG. 1.
a developer station ES1, ES2 to develop the charge images on the charge image carrier 104, 204 into toner images—for example, the developer stations respectively have, for example, a rotating developer roller 101, 201 that transports a liquid developer having at least carrier fluid and electrically charged toner particles past the charge image carrier 104, 204. The design of a corresponding developer station ES is known; refer to WO 2005/013013 A2. An image film made of carrier fluid with toner images embedded in it is thereby generated on the charge image carrier 104, 204. The liquid developer is supplied to the developer roller 101, 201 (for example via an inking roller 102, 202); after the development of the charge images on the developer roller 101, 201 remaining liquid developer can be cleaned off by a cleaning roller 103, 203. The described embodiment of the developer station ES1, ES2 is only an example.
a transfer unit TE1, TE2 for the transfer printing of the image film with the developed charge images onto the printing substrate 1. The respective transfer unit TE1, TE2 has a transfer element 105, 205 (for example an elastic transfer roller or a transfer belt) and a counter-pressure element (for example a counter-pressure roller) between which the printing substrate 1 is directed through. In addition to this, a conditioning unit KE1, KE2 can be provided in order to influence the image film on the transfer element 105, 205, for example by supplying carrier fluid. The transfer element 105, 205 accepts the image film from the charge image carrier 104, 204 at a transfer point and transports this to the printing substrate 1. The residual image film remaining on the transfer element 105, 205 after the transfer printing can be cleaned off by a cleaning unit 113, 213, for example a cleaning roller with a blade functioning as a scraper.
a fixing station 400. The fixing can take place in a known manner via the use of heat, for example using radiant heat.

In the transport of the liquid developer from the developer roller 101, 201 to the charge image carrier 104, 204 and of the image film from the charge image carrier 104, 204 to the printing substrate 1, toner particles in the carrier fluid migrate to the transfer printing zone 107, 207; in the transfer printing zone 107, 207 the toner images then migrate in the carrier fluid to the printing substrate 1. The image film made of carrier fluid and toner particles on the printing substrate 1 runs through the fixing station 400; there the image film is fixed in that the toner particles are fused, wherein the carrier fluid is vaporized.

It is an object of the preferred embodiment to recover the carrier fluid again from the carrier fluid vapor in the fixing station 400 and to reuse the recovered carrier fluid. For this a carrier fluid recovery device 500 is provided that is arranged between the fixing station 400 and the conditioning units KE1, KE2. The recovered carrier fluid can then be used via the conditioning units KE1, KE2 to condition the image film on the transfer element 105, 205.

The carrier fluid recovery device 500 can have conduits 501, 502, a recovery unit 505, a reservoir 506 and conduits 504, 503. The vapor (made of carrier fluid) arising in the fixing can be transferred via the conduit 501 to the recovery unit 505; there the vapor is re-condensed into carrier fluid in a known manner. The recovered carrier fluid is stored in the reservoir 506 after transfer via the conduit 502 in order to be supplied from the reservoir 506 via the conduits 503, 504 to the conditioning units KE1, KE2. The feed can be adjusted, for example, via pumps (not shown) arranged in the conduits 503, 504 that are controlled by sensors measuring the fill level in the conditioning units KE1, KE2, for example. A significant portion of the carrier fluid can be reused in this manner, wherein the carrier fluid circulates precisely where it is required in a small loop. This carrier fluid can then be applied to the image film on the transfer element 105, 205 in order to be able to implement the transfer of the toner particles from the transfer element 105, 205 to the printing substrate 1 in the carrier fluid according to the electrophoresis principle.

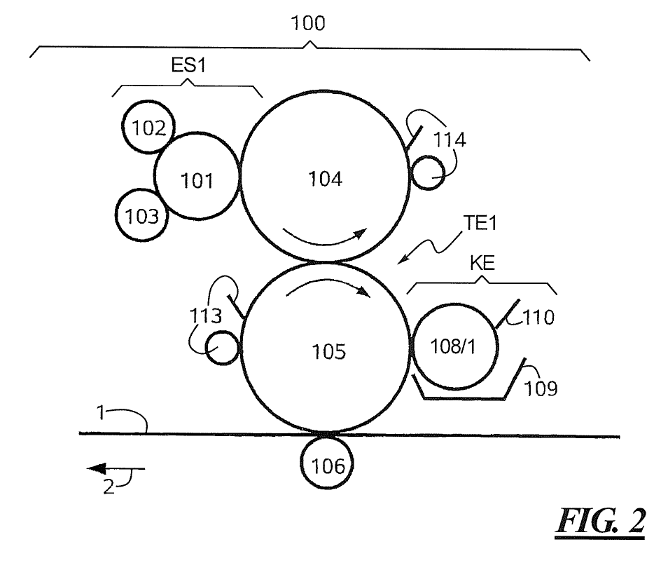

The conditioning units KE1, KE2 that are shown schematically in FIG. 1 can be executed corresponding to FIGS. 2 through 4. Its realization is thereby shown only for the print group 100; the realization correspondingly applies for the print group 200.

According to FIG. 2, the conditioning unit KE has a trough 109 having carrier fluid and a roller 108/1 that runs in the trough 109 and rests on the transfer element 105. The roller 108/1 can be realized as a hard raster roller with cups that scoops carrier fluid from the trough 109. Excess carrier fluid can be stripped from the raster roller 108/1 by a blade 110, such that the raster roller 108/1 offers carrier fluid to the transfer element 105 only in the filled cups. The raster roller 108/1 can be set at an electrical potential that is polarized such that an electrical field repelling the toner particles between transfer element 105 and raster roller 108/1 is adjusted. A transfer of print image portions into the trough 109, which could lead to a degradation of the print image on the printing substrate 1, is thereby avoided. The quantity of carrier fluid that is transferred to the transfer element 105 is established by the depth of the cups of the raster roller 108/1.

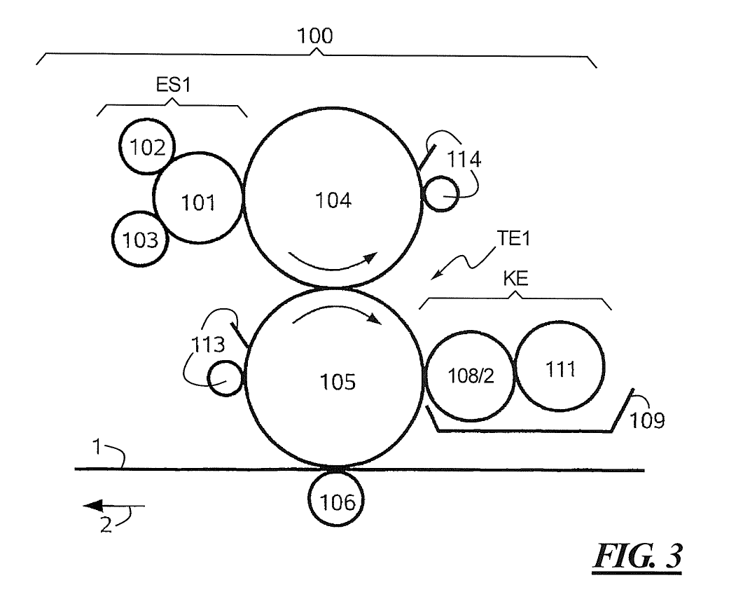

FIG. 3 shows a further example of a conditioning unit KE. Here a smooth, hard roller 108/2 is wetted with the carrier fluid in the trough 109 and transports the adhering layer of carrier fluid to the transfer element 105. The applied quantity of carrier fluid can be limited beforehand to the desired degree by an elastic roller 111 that rests on the roller 108/2. An electrical potential repelling the toner particles can in turn be applied to the roller 108/2, such that no toner particles transfer from the transfer element 105 to the roller 108/2.

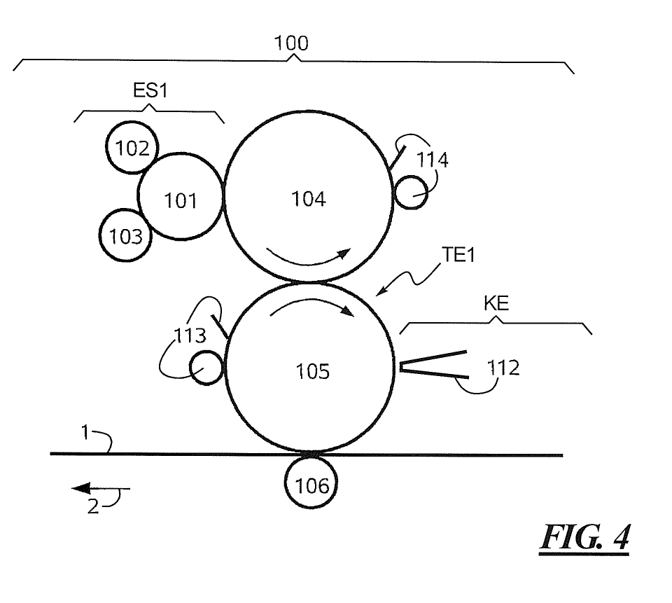

FIG. 4 shows an additional embodiment of the conditioning unit KE. Here the carrier fluid is transferred directly to the transfer element 105 via a nozzle 112. In this case the quantity of carrier fluid is established by the applied overpressure, for example via a pump arranged in the conduit 504 and the geometric dimensions of the opening of the nozzle 112. In this embodiment an electrical field can likewise be used in order to avoid a disruption of the print image.

It is advantageous if cleaning units 113, 114—made up of a roller and a blade, for example—are arranged on the transfer element 105, 205 and on the charge image carrier 104, 204 in order to be able to optimally keep the recovered carrier fluid entirely out of the upstream printing process before the transfer to the transfer element.

The preferred embodiments have been described in connection with a printing apparatus DS with two print groups 100, 200. However, this is only an example. The shown embodiment of the developer station ES is likewise only an example. The recovery unit 505 can be executed in a known manner. Examples of a recover unit 505 can be learned from U.S. Pat. No. 5,676,738 or EP 0 422 463 B1.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

I claim as my invention:

1. An electrographic printing apparatus, comprising:
a charge image carrier on which are generated charge images of images to be printed;
a developer station that, with a liquid developer having at least carrier fluid and toner particles, develops the charge images into an image film comprising carrier fluid and embedded toner images;
a transfer unit having a transfer element, said transfer unit receiving said image film from the charge image carrier at a transfer point and transfers said image film onto a printing substrate in a transfer printing zone;
a fixing station that fixes the image film on the printing substrate;
a carrier fluid recovery device arranged between the fixing station and the transfer unit, said carrier fluid recovery device recovering carrier fluid from carrier fluid vapor occurring in the fixing station and supplying the recovered carrier fluid to the transfer unit; and
the carrier fluid recovery device being connected with the transfer unit.

2. The printing apparatus according to claim 1 in which the transfer unit comprises a conditioning unit arranged adjacent to the transfer element, said conditioning unit applying carrier fluid to the image film on the transfer element, and the carrier fluid recovery device being connected with the conditioning unit.

3. The printing apparatus according to claim 2 wherein the carrier fluid recovery device has:
a recovery unit connected via a conduit with said fixing station; and
a reservoir that is connected with the recovery unit to store the recovered carrier fluid, and is also connected with the conditioning unit to supply it with carrier fluid.

4. The printing apparatus according to claim 2 wherein the conditioning unit provides a trough filled with carrier fluid and a roller running through the trough, the roller for transferring the carrier fluid resting on the transfer element.

5. The printing apparatus according to claim 4 wherein a raster roller on which a blade rests is provided as said roller.

6. The printing apparatus according to claim 4 wherein a smooth hard roller on which an elastic smooth roller rests is provided as said raster roller.

7. The printing apparatus according to claim 2 wherein the conditioning unit provides a nozzle that applies the carrier fluid onto the transfer element.

8. The printing apparatus according to claim 4 wherein an electrical potential is applied at the roller or a nozzle, said potential being polarized such that the electrical field existing between the transfer element and the roller or the nozzle exerts a repulsive effect on the toner particles in a direction of the transfer element.

9. The printing apparatus according to claim 1 wherein a cleaning unit is arranged at the transfer element after the transfer printing zone in order to clean residual carrier fluid off of the transfer element.

10. The printing apparatus according to claim 1 wherein a cleaning unit is arranged at the charge image carrier after the transfer point in order to clean residual carrier fluid off of the charge image carrier.

11. An electrographic printing apparatus, comprising:
a charge image carrier on which are generated charge images of images to be printed;
a developer station that, with a liquid developer having at least carrier fluid and toner particles, develops the charge images into an image film comprising carrier fluid and embedded toner images;
a transfer unit receiving said image film from the charge image carrier and transfers said image film onto a printing substrate in a transfer printing zone;
a fixing station that fixes the image film on the printing substrate;
a carrier fluid recovery device arranged between the fixing station and the transfer unit, said carrier fluid recovery device recovering carrier fluid from carrier fluid vapor occurring in the fixing station and supplying the recovered carrier fluid to the transfer unit; and
the carrier fluid recovery device being connected with the transfer unit.
